(19) United States
(12) Patent Application Publication
(10) Pub. No.: US 2013/0257687 A1
(43) Pub. Date: Oct. 3, 2013

(54) DISPLAY SYSTEM, DISPLAY DEVICE, AND RELATED METHODS OF OPERATION

(71) Applicant: SAMSUNG ELECTRONICS CO., LTD., Suwon-si (KR)

(72) Inventors: WOOHYUNG CHUN, YONGIN-SI (KR); IL PARK, SEOUL (KR)

(73) Assignee: SAMSUNG ELECTRONICS CO., LTD., SUWON-SI (KR)

(21) Appl. No.: 13/773,036

(22) Filed: Feb. 21, 2013

(30) Foreign Application Priority Data
Mar. 30, 2012 (KR) 10-2012-0033572

(51) Int. Cl. G06F 3/14

(52) U.S. Cl. CPC G06F 3/14
USPC 345/2.3

(57) ABSTRACT

A display system comprises a first display device configured to transmit information associated each of with multiple frames in slice units, and a second display device configured to receive the information from the first display device. Where a latency of at least one slice of a selected frame among the multiple frames exceeds a predetermined time, the first display device skips a transfer operation of at least one frame among the multiple frames.

### CROSS-REFERENCE TO RELATED APPLICATIONS

This application claims priority under 35 U.S.C. §119 to Korean Patent Application No. 10-2012-0033572 filed Mar. 30, 2012, the subject matter of which is hereby incorporated by reference.

### BACKGROUND OF THE INVENTION

The inventive concept relates generally to image display technologies. More particularly, certain embodiments relate to a display system, a display device that can be used in the display system, and related methods of operation.

Some electronic networks allow an image or image stream to be displayed concurrently multiple display devices. For example, some home entertainment networks may allow a digital video stream to be displayed concurrently on multiple digital televisions within the network. In general, such networks can be referred to as display systems due to their expanded display capability.

A display system can be implemented using various alternative network communication technologies, with examples including wireless protocols such as Wi-Fi or WiDi, or wired protocols such as Ethernet, USB, and so on. In addition, a display system can incorporate many alternative types of end devices, such as portable computers or tablets, smart phones, cameras, and many others. For instance, one common form of display system displays information from a portable device, such as a smartphone, on a high definition television (HDTV).

In order to improve the performance of new and existing display systems, researchers are actively engaged in efforts to improve the coordination of display operations among different display devices and other network components. An example of such coordination includes timing synchronization of displayed images on multiple different devices.

### SUMMARY OF THE INVENTION

In one embodiment of the inventive concept, a display system comprises a first display device configured to transmit information associated each of with multiple frames in slice units, and a second display device configured to receive the information from the first display device. Where a latency of at least one slice of a selected frame among the multiple frames exceeds a predetermined time, the first display device skips a transfer operation of at least one frame among the multiple frames.

In another embodiment of the inventive concept, a display device comprises a first buffer unit configured to receive information associated with a frame of an image stream from an external device in slice units, a second buffer unit configured to receive information associated with a slice from the first buffer unit and to store information associated with multiple slices, and a control unit configured to control the first and second buffer units and to check information associated with a slice received at the first buffer unit periodically.

In another embodiment of the inventive concept, a method of operating a display system comprises transmitting, by a first display device, information associated each of with multiple frames in slice units, receiving, by a second display device, the information transmitted by the first display device, and, where a latency of at least one slice of a selected frame among the multiple frames exceeds a predetermined time, skipping, by the first display device, a transfer operation of at least one frame among the multiple frames.

These and other embodiments of the inventive concept can potentially improve the performance of display systems by adjusting the concurrent display of images on different devices according to real-time constraints.

### BRIEF DESCRIPTION OF THE DRAWINGS

The drawings illustrate selected embodiments of the inventive concept. In the drawings, like reference numbers indicate like features, and the relative sizes of various features may be exaggerated for clarity of illustration.

FIG. 1 is a diagram illustrating a display system according to an embodiment of the inventive concept.

FIG. 2 is a diagram illustrating an operation of the display system of FIG. 1 according to an embodiment of the inventive concept.

FIGS. 3 and 4 are diagrams illustrating operations of a first display device in FIG. 1 according to an embodiment of the inventive concept.

FIG. 5 is a block diagram illustrating a second display device of FIG. 1 according to an embodiment of the inventive concept.

FIGS. 6 and 7 are diagrams for describing operations of a CPU in FIG. 5 according to an embodiment of the inventive concept.

FIGS. 8 and 9 are diagrams for describing operations of a CPU in FIG. 5 according to an embodiment of the inventive concept.

FIG. 10 is a diagram illustrating an under-run phenomenon generated when a second display device in FIG. 5 does not support a display latency maintain operation according to an embodiment of the inventive concept.

FIG. 11 is a diagram illustrating a display latency maintain operation of a second display device in FIG. 5 according to an embodiment of the inventive concept.

FIG. 12 is a flowchart illustrating operations of a second display device in FIG. 5 according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, the terms “first”, “second”, “third”, etc., are used to describe various features, but the described features should not be limited by these terms. Rather, these terms are used merely to distinguish between different features. Thus, a first feature could alternatively be termed a second feature, and vice versa, without materially altering the meaning of the relevant description.

Spatially relative terms, such as “beneath”, “below”, “lower”, “under”, “above”, “upper” and the like, may be used herein for ease of description to describe one feature's relationship to another feature(s) as illustrated in the drawings. The spatially relative terms are intended to encompass different orientations of the device in use or operation in addition to the orientation depicted in the drawings. For example, if the device in the figures is turned over, features described as “below” or “beneath” or “under” other elements or features would then be oriented “above” the other features. Thus, the terms “below” and “under” can encompass both an orientation of above and below. The device may be otherwise oriented (rotated 90 degrees or at other orientations) and the spatially relative descriptors used herein interpreted accordingly. In addition, where a layer is referred to as being “between” two layers, it can be the only layer between the two layers, or one or more intervening layers may also be present.

The terminology used herein is for the purpose of describing particular embodiments only and is not intended to limit the scope of the inventive concept. As used herein, the singular forms “a”, “an” and “the” are intended to include the plural forms as well, unless the context clearly indicates otherwise. Terms such as “comprises”, “comprising,” “includes”, “including”, “having”, etc., indicate the presence of stated features but do not preclude the presence or addition of other features. As used herein, the term “and/or” indicates any and all combinations of one or more of the associated listed items.

Where a feature is referred to as being “on”, “connected to”, “coupled to”, or “adjacent to” another feature, it can be directly on, connected, coupled, or adjacent to the other feature, or intervening features may be present. In contrast, where a feature is referred to as being “directly on,” “directly connected to”, “directly coupled to”, or “immediately adjacent to” another feature, there are no intervening features present.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

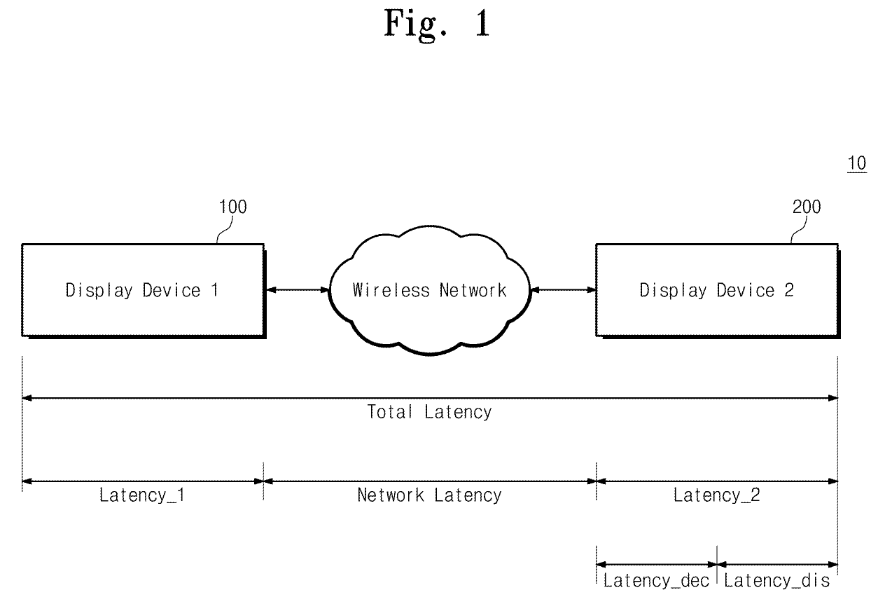

FIG. 1 is a diagram illustrating a display system 10 according to an embodiment of the inventive concept.

Referring to FIG. 1, display system 10 comprises a first display device 100 and a second display device 200. First and second display devices 100 and 200 exchange image information through a wireless network.

First and second display devices 100 and 200 provide a user with the same image. For example, first display device 100 may send information associated with an image being displayed to second display device 200. Second display device 200 may process information associated with a corresponding image and display the same image as displayed on first display device 100.

As illustrated in FIG. 1, a time difference may exist between an image displayed by first display device 100 and an image displayed by second display device 200, which will be referred to as a total latency.

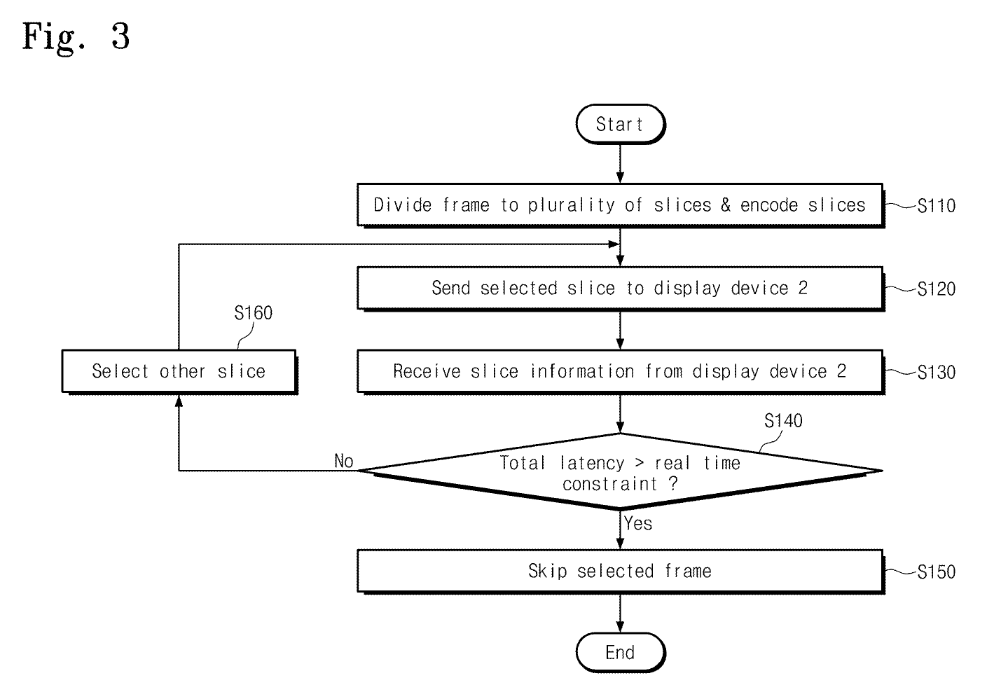

Display system 10 may control the total latency so that it is restricted within a predetermine time. In other words, display system 10 may restrict a time difference between an image displayed by first display device 100 and an image displayed by second display device 200, to a predetermined time. This will be more fully described with reference to FIGS. 3 to 12.

Where a time difference on the same image displayed by different display devices is below 20 ms, a user may experience an image as if it is displayed at the respective display devices at the same time. Accordingly, this experience can be achieved with respect to first and second display devices 100 and 200 by setting the predetermined time below 20 ms.

The predetermined time constitutes one form of a real time constraint. Accordingly, for simplicity, in the above example it may be said that the real time constraint is set to 20 ms. However, the real time constraint is changed variously according to a display device type, a standard specification of the maker, the technical skill of the maker, and the like.

In the example of FIG. 1, the total latency is divided into a first latency, a second latency, and a network latency. The first latency is a time consumed by first display device 100, for example, in an encoding operation. The second latency is a time consumed by second display device 200, for example, in a decoding operation. The network latency is a time consumed at a wireless network transfer operation. The second latency is divided into a decoding latency Latency_dec taken to perform a decoding operation and a display latency Latency_dis taken to perform a display operation.

First and second display devices 100 and 200 can be implemented by any of various alternative types of electronic devices. For example, where a user wants to display an image from a small-screen electronic device on a large-screen at the same time, first display device 100 may be implemented by a relatively small-sized mobile device such as a smart phone, and second display device 200 may be implemented by a relatively large-sized electronic device such as HDTV.

In certain examples, first display device 100 may be implemented by a smart phone such as an iPhone, Galaxy, or the like, a tablet PC such as iPad, Galaxy tab, or the like, or a notebook computer. Second display device 200 may be implemented by HDTV or a large-sized screen. Alternatively, second display device 200 can be implemented by the same electronic device as first display device 100.

In certain embodiments, the wireless network can be implemented using Ethernet, wireless LAN, and the like. Alternatively, the wireless network may be implemented using a Wi-Fi or Bluetooth technology. Alternatively, the wireless network may be implemented using a Wi-Di technology. For explanation purposes, it will be assumed that display system 10 is implemented using the Wi-Di standard.

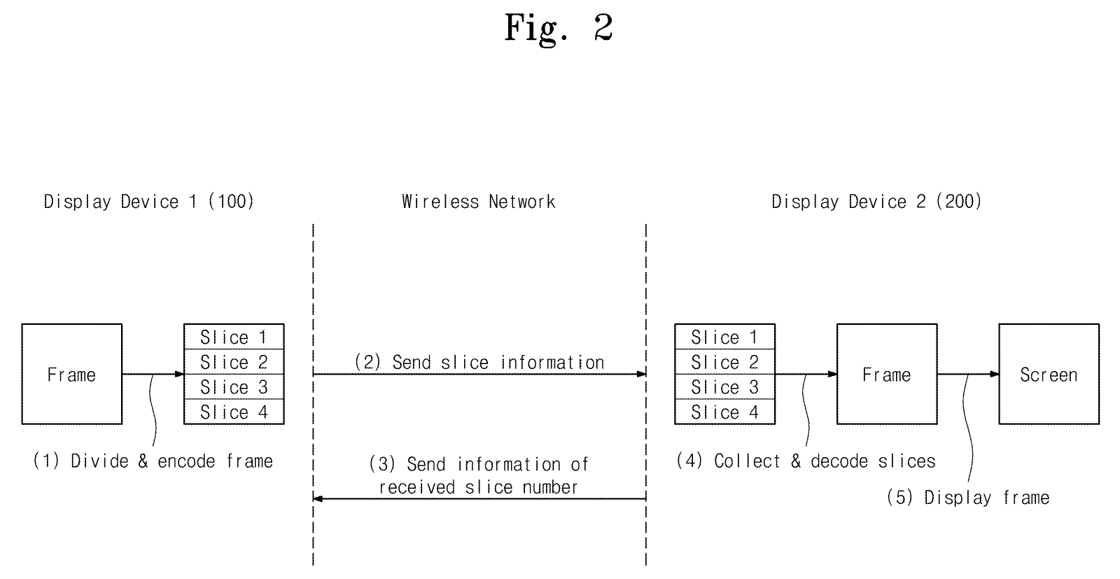

FIG. 2 is a diagram illustrating an operation of display system 10 according to an embodiment of the inventive concept. In this example, display system 10 displays an image stream comprising multiple frames. For ease of description, only one frame is shown in FIG. 2.

Referring to FIG. 2, in operation (1), first display device 100 divides a frame into multiple slices and decodes the plurality of slices, respectively. In FIG. 2, the frame is divided into four slices. However, the inventive concept is not limited thereto. Also in FIG. 2, encoding is performed after the frame is divided into slices. However, the inventive concept is not limited thereto. Alternatively, for example, first display device 100 may encode a frame prior and then divide the encoded frame into multiple slices.

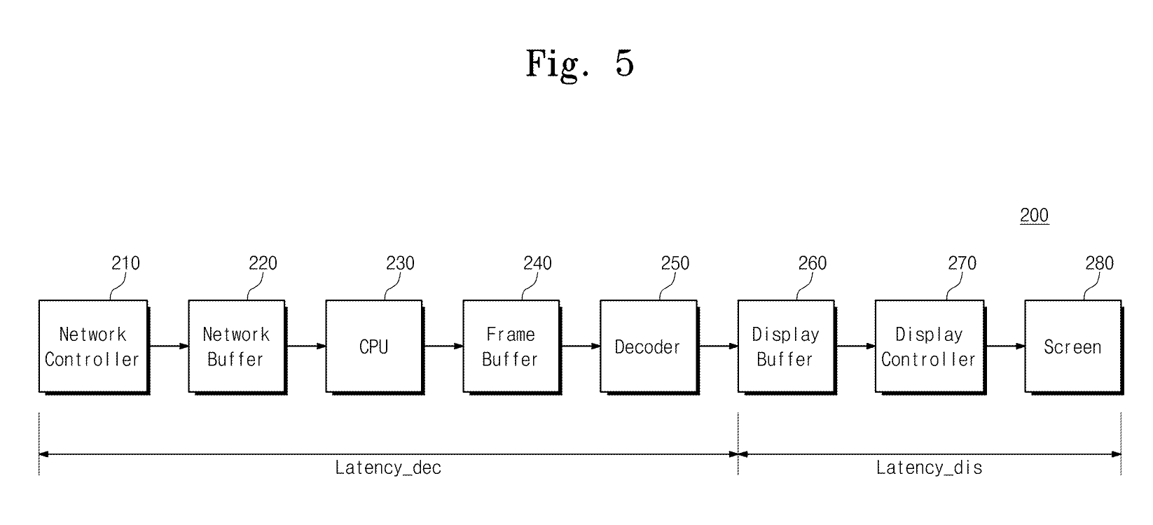

Thereafter, in operation (2), first display device 100 provides second display device 200 with information associated with one selected from the plurality of slices through a wireless network. Second display device 200 temporarily stores the input slice to perform a decoding operation and a display latency maintaining operation on the input slice. The decoding operation and display latency maintaining operation of second display device 200 are more fully described with reference to FIGS. 5 to 12.

Next, in operation (3), second display device 200 provides first display device 100 with information associated with the slice experiencing the decoding operation and display latency maintaining operation. The information associated with the slice comprises its number and information associated with a completion point of time.

First display device 100 calculates a total latency of an input slice based on information associated with the input slice. Where the total latency of the input slice is less than a real time constraint, first display device 100 stops transferring a frame to which the input slice belongs (or, a next frame of the input slice). Thereafter, operations (1), (2), and (3) are iteratively performed with respect to a next frame of a skipped slice.

Where the total latency of the input slice is less than a real time constraint, first display device 100 sends information on another slice of the same frame to second display device 200. Thereafter, operations (1), (2), and (3) are iteratively performed.

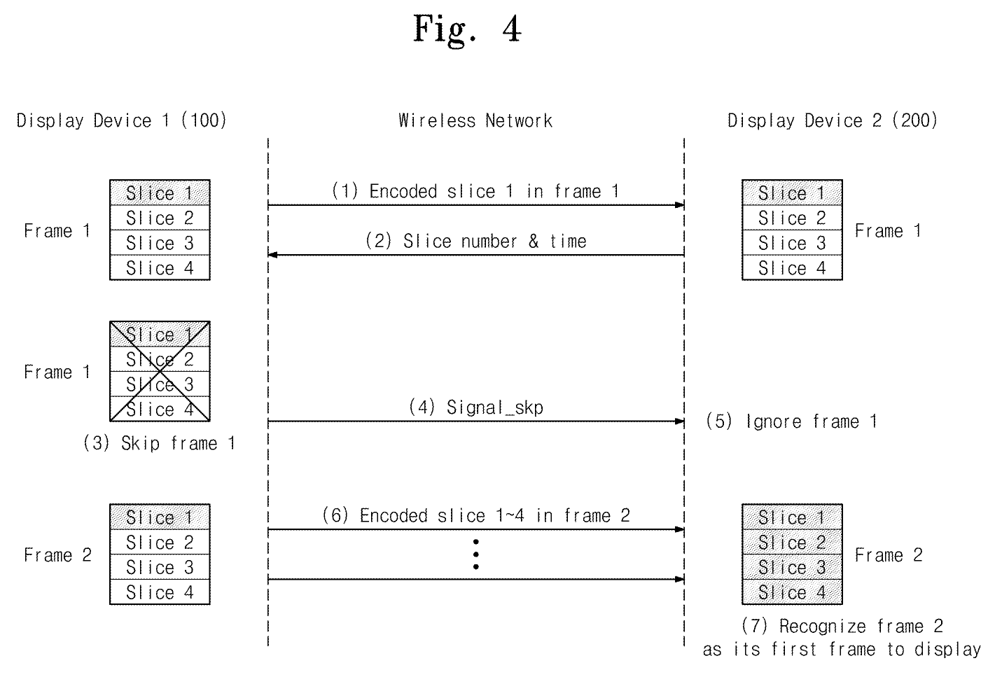

As indicated by the foregoing, first display device 100 calculates a total latency of each slice based on information associated with a slice input from second display device 200, and it skips a transfer operation on a frame to which a corresponding slice belongs (or, a next frame of a corresponding frame). Thus, first display device 100 satisfies the real time constraint by skipping a frame which does not satisfy a real time constraint (or, a next frame of a corresponding frame). First display device 100 may be more fully described with reference to FIGS. 3 and 4.

In operation (4), second display device 200 decodes information on each slice sequentially input from first display device 100. Then, in operation (5), second display device 200 performs a display operation on a corresponding frame.

In certain other embodiments, second display device 200 performs a set of operations for maintaining an average total latency of slices belonging to a frame within a real time constraint. For example, where jitter on a predetermined slice of a frame is generated, second display device 200 may perform an operation of replacing a corresponding slice with a similar slice of previously input slices. This will be more fully described with reference to FIGS. 5 to 12.

FIGS. 3 and 4 are diagrams for describing operations of first display device 100 of FIG. 1 according to an embodiment of the inventive concept. Below, an operation of first display device 100 at a transfer of a frame will be more fully described with reference to FIGS. 3 and 4. For ease of description, it is assumed that one frame is divided into four slices.

Referring to FIGS. 3 and 4, in operation S110, first display device 100 divides a frame into multiple slices and then encodes the slices. Alternatively, first display device 100 may divide the frame after the encoding.

In operation S120, first display device 100 sends a slice selected of the plurality of slices to second display device 200. For example, as illustrated in FIG. 4, first display device 100 may send a first slice of a first frame to second display device 200.

In operation S130, first display device 100 receives slice information from second display device 200. That is, as illustrated in FIG. 4, second display device 200 performs decoding and display latency maintaining operations on the first slice, and sends a number of the first slice and information on a display latency maintain completion point of time to first display device 100.

In operation S140, first display device 100 calculates a total latency based on the input slice information to judge whether a total latency is more than a real time constraint. That is, first display device 100 selects a slice for a total latency based on the input slice number, and it calculates a total latency of a corresponding slice based on information on a display latency maintain completion point of time.

If the total latency is less than a real time constraint (S140=No), in operation S160, first display device 100 selects another slice belonging to the same frame. Afterwards, a transfer operation on a selected slice may be performed in the same manner as described above.

If the total latency is more than a real time constraint (S140=Yes), in operation S150, first display device 100 may skip a frame to which a corresponding slice belongs. That is, as illustrated in FIG. 4, first display device 100 stops transferring the first frame to send a skip signal Signal_skp to second display device 200. Second display device 200 ignores the first frame in response to skip signal Signal_skp.

Where a transfer operation of a selected frame is ended or a selected frame is skipped, a transfer operation of a next frame may be performed in the same manner. For example, as illustrated in FIG. 4, where the first frame is skipped, a transfer operation on slices of a second frame may be performed in the same manner as the first frame. Where all slices of the second frame satisfy a total latency, second display device 200 may recognize the second frame as a first frame for displaying.

As described with reference to FIGS. 3 and 4, where a total latency of a predetermined slice is more than a real time constraint, first display device 100 skips a frame to which the predetermined slice belongs. Thus, a real time constraint between the first and second display devices 100 and 200 may be satisfied.

The above described embodiments can be modified in various ways. In one example, where a total latency of a predetermined slice is more than a real time constraint, first display device 100 may skip a next frame of a frame rather than a frame to which the predetermined slice belongs. During a time where a frame to which a predetermined slice belongs is displayed at second display device 200, first display device 100 may skip a next frame of a frame which the predetermined slice belongs to.

In some embodiments, first display device 100 receives information associated with a slice arrival point of time or a decoding completion point of time on a slice from second display device 200, not information associated with a display maintain completion point of time. For example, in the event that a predetermined time for a decoding latency Latency_dec or a display latency Latency_dis is determined, first display device 100 may infer a total latency by calculating only a network latency. In some other embodiments, first display device 100 may receive information on a slice arrival point of time or a decoding completion point of time on a slice from second display device 200.

The network latency required to transfer a slice from first display device 100 to second display device 200 may vary according to different circumstances. To address this variation, second display device 200 may keep a total latency within a real time constraint by replacing a slice, not transferred to second display device 200 within a given time, with a similar slice.

In the event that a slice is not received within a given time (hereinafter, referred to as generation of jitter), it may be replaced with a slice, similar to the slice not received, from previously received slices. This will be more fully described with reference to FIGS. 5 to 12.

FIG. 5 is a block diagram illustrating second display device 200 of FIG. 1 according to an embodiment of the inventive concept.

Referring to FIG. 5, second display device 200 comprises a network controller 210, a network buffer 220, a CPU 230, a frame buffer 240, a decoder 250, a display buffer 260, a display controller 270, and a screen 280.

Network controller 210 receives a slice from a first display device 100 and sends it to network buffer 220. Network buffer 220 temporarily stores the input slice, and sends the input slice to frame buffer 240 in response to control of CPU 230. Network buffer 220 is typically smaller in size than frame buffer 240. For example, network buffer 220 may be formed to store one or more slices. For example, network buffer 220 may be formed of a First-In-First-Out (FIFO). However, the inventive concept is not limited thereto. Network buffer 220 may be implemented to have the same size as frame buffer 240.

CPU 230 may control an overall operation of second display device 200. CPU 230 controls transferring of a slice into frame buffer 240 from network buffer 220. Frame buffer 240 receives a slice from network buffer 220 and stores multiple slices belonging to each frame.

Decoder 250 is configured to decode a slice stored in frame buffer 240. Decoder 250 transfers the decoded slice to display buffer 260. Display buffer 260 stores decoded slices. Display controller 270 controls an operation of displaying the decoded slices on screen 280.

Components 210, 230, and 270 can be implemented by one module. In this case, a module including components 210, 230, and 270 may be referred to as a control unit. As illustrated in FIGS. 1 and 5, a time taken until decoding of an input slice is ended may be referred to as a decoding latency Latency_dec, and a time taken until a decoded slice is displayed may be referred to as a display latency Latency_dis.

In some embodiments, CPU 230 is configured to periodically check whether a new slice is provided to network buffer 220. Where no new slice is provided to network buffer 220, CPU 230 determines whether a slice having spatial locality or temporal locality with a slice not received exists among previously received slices.

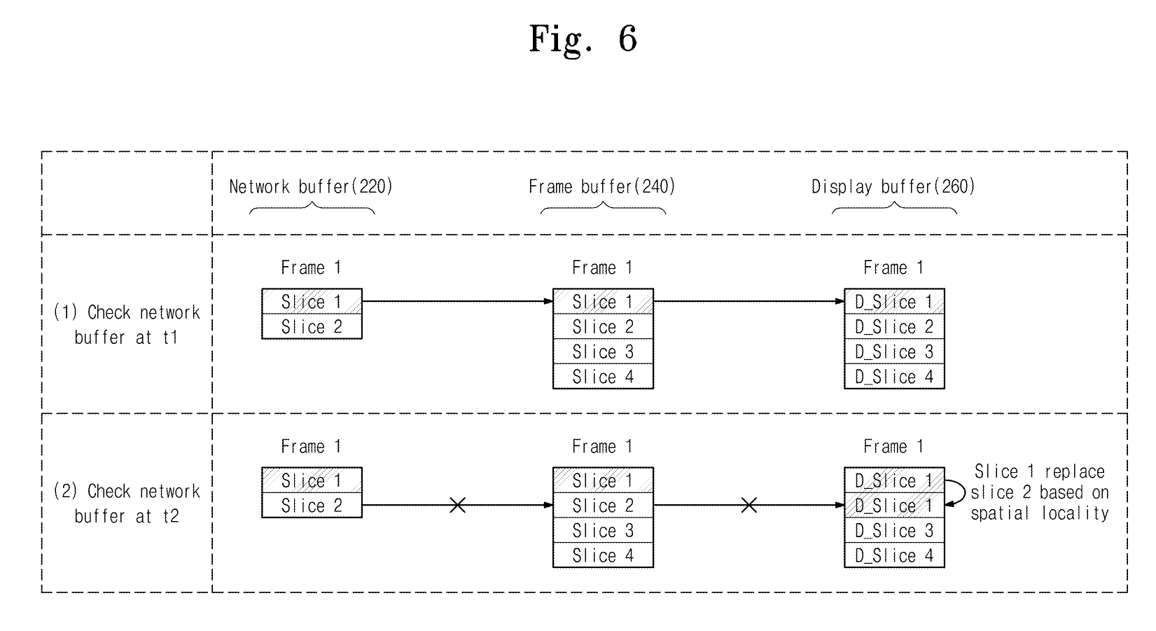

If a similar slice exists, CPU 230 replaces the slice not received with a similar slice. This will be more fully described with reference to FIGS. 6 to 9. If no similar slice exists, CPU 230 provide first display device 100 with information indicating that a slice is not received, and first display device 100 performs a skip operation on a frame to which a corresponding slice belongs.

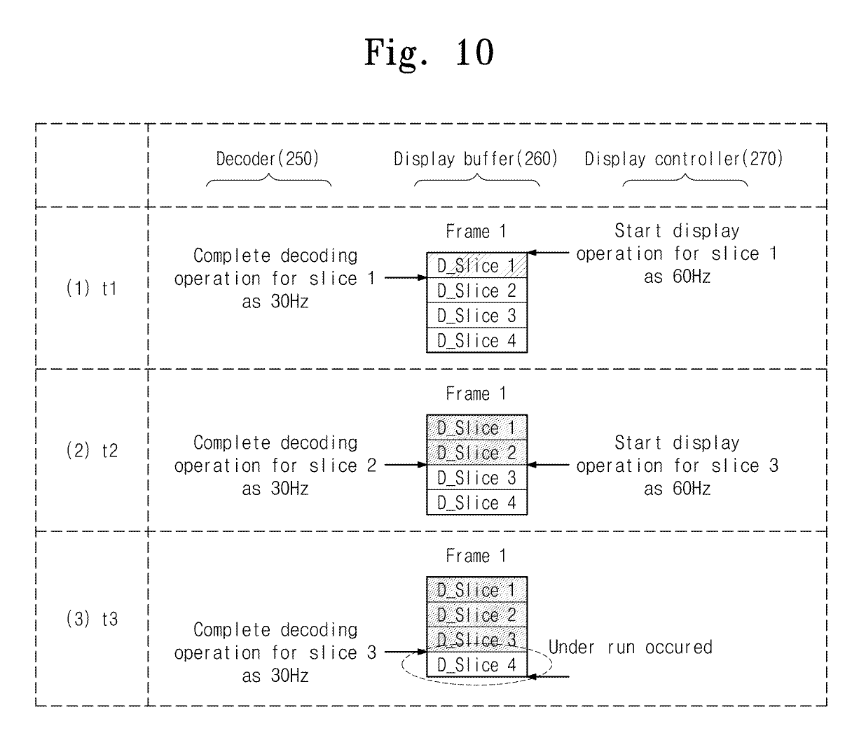

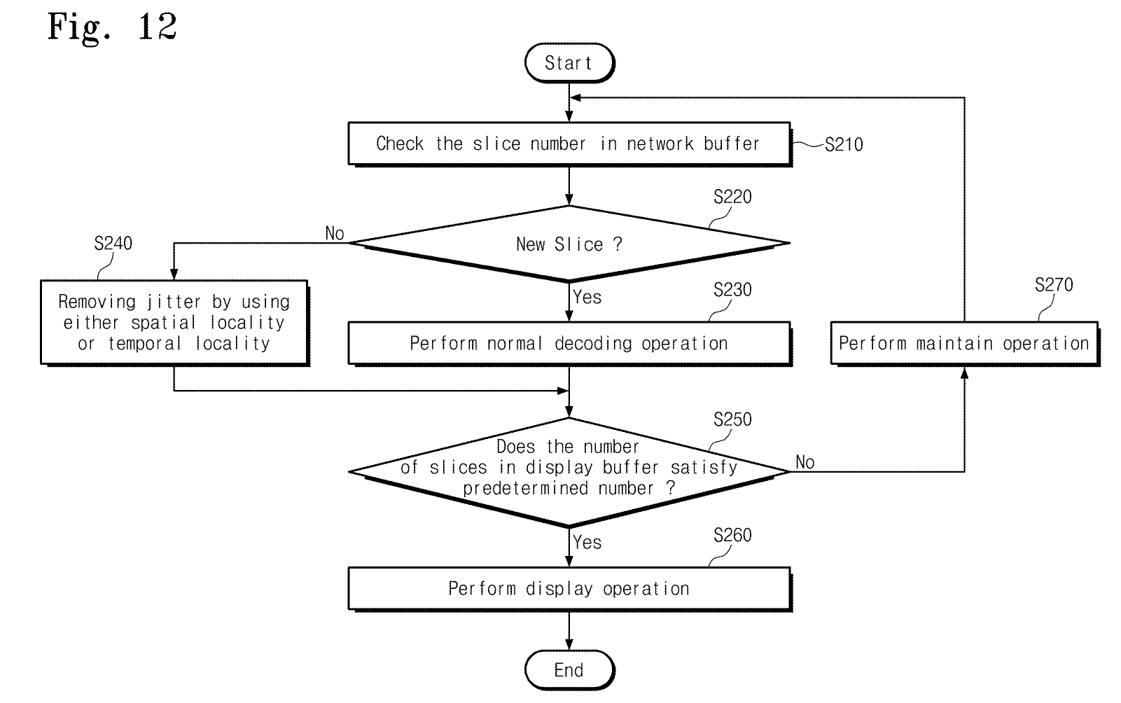

In certain other embodiments, display controller 270 performs a display latency maintain operation. In general, a decoding speed of decoder 250 may be different from a display speed of controller 270. Thus, display controller 270 may perform a display operation after performing a decoding operation on predetermined slices such that no under-run phenomenon is generated. This will be more fully described with reference to FIGS. 10 and 12.

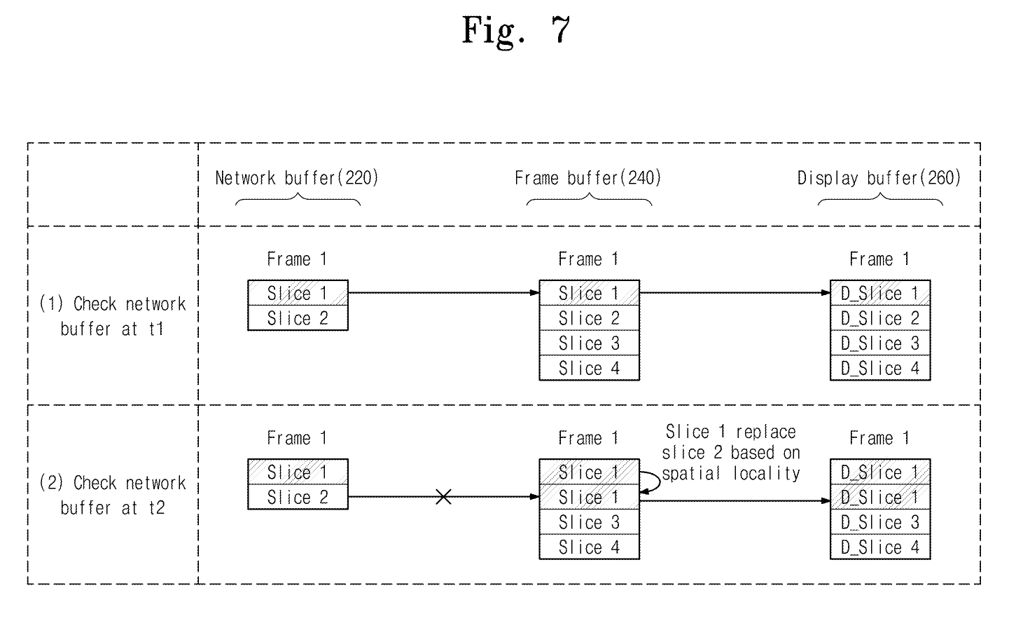

FIGS. 6 and 7 are diagrams for describing an operation of CPU 230 of FIG. 5 which performs a slice replacing operation on a slice not received using spatial locality. In FIGS. 6 and 7, it is assumed that a network buffer 220 stores two slices. Also, it is assumed that data stored in network buffer 220 at times t1 and t2 are identical to each other.

Referring to FIG. 6, at a first time t1, CPU 230 checks data stored in network buffer 220. Because a first slice is stored in network buffer 220, CPU 230 sends the first slice to a frame buffer 240 from network buffer 220. Decoder 250 decodes the first slice stored in frame buffer 240 and transfers decoded slice D_Slice 1 to display buffer 260.

At a second time t2, CPU 230 checks data stored in network buffer 220. Because data stored in network buffer 220 at second time t2 is identical to that at first time t1, CPU 230 does not perform an operation of transfer a slice to frame buffer 240 from network buffer 220. Instead, CPU 230 replaces a slice not received using the first slice, similar to the slice not received, from among previously input slices.

Adjacent slices of multiple slices in a frame may have similar image information. This may be referred to as spatial locality. Thus, although a slice not received may be replaced with an adjacent slice, image information of a corresponding frame may be maintained overall.

Referring to FIG. 6, the first slice may be adjacent to the second slice not received. Thus, CPU 230 may store the decoded first slice D_Slice 1 at a place of display buffer 260 corresponding to the decoded second slice D_Slice 2. In this case, the entire image information of the first frame may not be varied according to the spatial locality. Also, second display device 200 may maintain a total latency of the first frame within a real time constraint by replacing a second slice, not received within a given time, with a similar slice (e.g., a first slice).

Although FIG. 6 illustrates an example where CPU 230 performs a slice replacing operation using a decoded slice of display buffer 260, the inventive concept is not limited to these conditions. For example, referring to FIG. 7, CPU 230 can perform a slice replacing operation using a slice of frame buffer 240. That is, in the event that a second slice is not received at second time t2, CPU 230 may replace the second slice not received, using a first slice of frame buffer 240. In this case, decoder 250 may decode the first slice instead of the second slice to transfer the decoded first slice D_Slice 1 to display buffer 260.

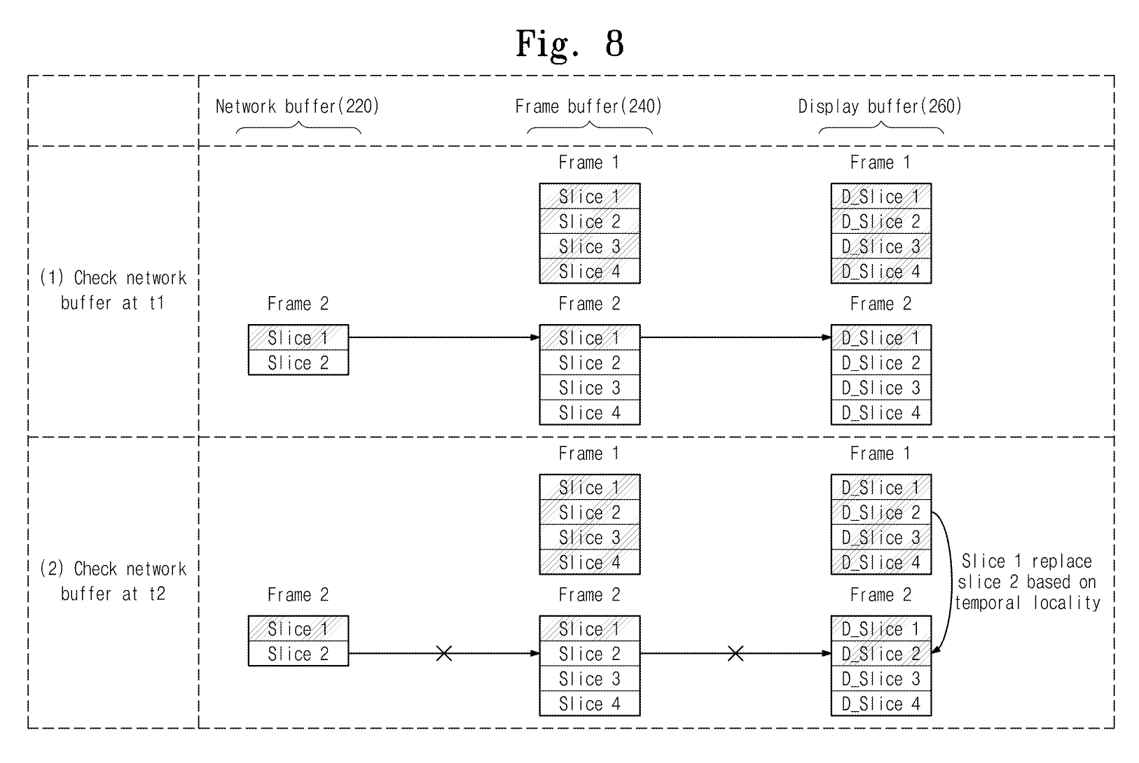

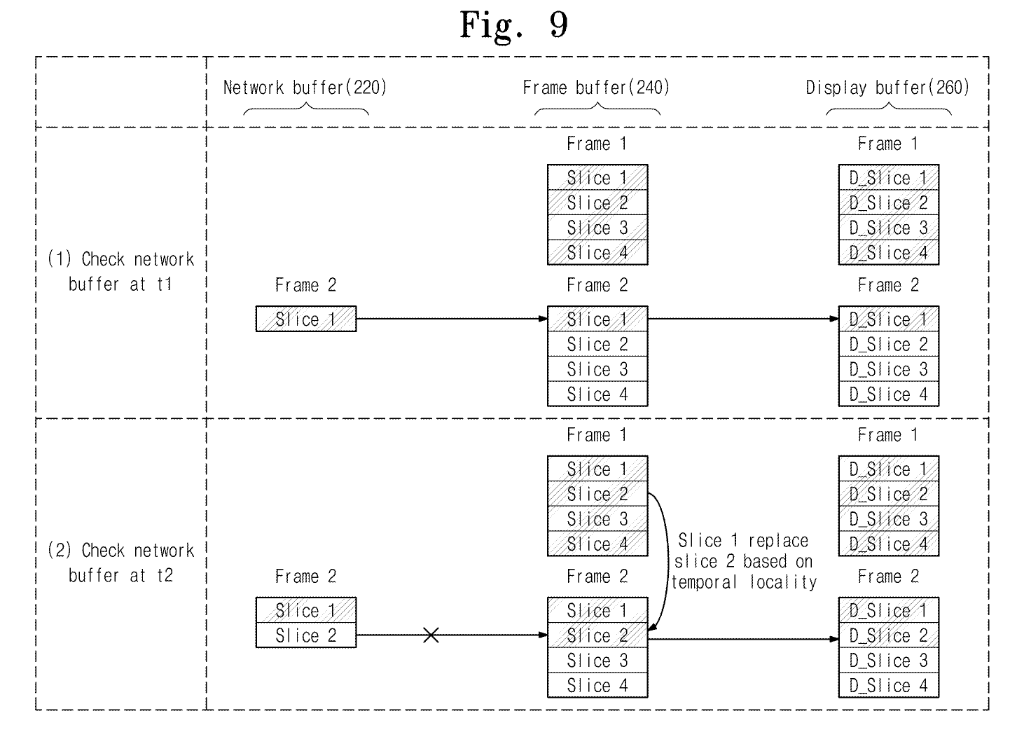

FIGS. 8 and 9 are diagrams for describing operations of CPU 230 of FIG. 5 which performs a slice replacing operation on a slice not received using temporal locality. For explanation purposes, it is assumed that network buffer 220 is configured to store two slices. Also, it is assumed that first and second slices are sequential in time. It is assumed that slices on the first frame are all received and decoded. Also, it is assumed that a second slice of the second frame is not received at a second time t2.

Referring to FIG. 8, at a first time t1, CPU 230 checks data stored in a network buffer 220. Because a first slice of a second frame is stored in network buffer 220, CPU 230 transfers the first slice of the second frame into a frame buffer 240 from network buffer 220. Decoder 250 decodes the first slice of the second frame stored in frame buffer 240, and the decoded first slice D_Slice 1 may be stored in a display buffer 260.

At a second time t2, CPU 230 checks data stored in network buffer 220. Because data stored in network buffer 220 at second time t2 is equal to data (i.e., the first slice) stored in network buffer 220 at first time t1, CPU 230 performs a slice replacing operation on a slice not received using temporal locality.

Frames sequential in time may have similar image information. For example, as illustrated in FIG. 8, because a second frame is provided following a first frame, the first and second frames may be continuing in time and have similar image information. This may be referred to as temporal locality. Thus, although a slice not received is replaced with a slice continuing in time, image information of a corresponding frame may be maintained overall.

In FIG. 8, the second slice of the second frame not received corresponds to the second slice of the first frame previously received according to the temporal locality. Thus, CPU 230 may replace the second slice of the second frame not received with the second slice of the first frame.

In this case, as illustrated in FIG. 8, CPU 230 performs a slice replacing operation using data stored in display buffer 260. That is, CPU 260 may perform a slice replacing operation using a decoded second slice of the first frame stored in display buffer 260.

In other embodiments, as illustrated in FIG. 9, CPU 230 may perform a slice replacing operation using data stored in frame buffer 240. That is, CPU 230 may replace the second slice of the second frame not received with the second slice of the first frame stored in frame buffer 240. Under these circumstances, decoder 250 may decode the replaced slice to store it at display buffer 260.

As described with reference to FIGS. 6 to 9, second display device 200 may perform a slice replacing operation on a slice not received, using spatial locality or temporal locality. Second display device 200 may maintain a total latency within a real time constraint by replacing a slice not received with a previously received slice.

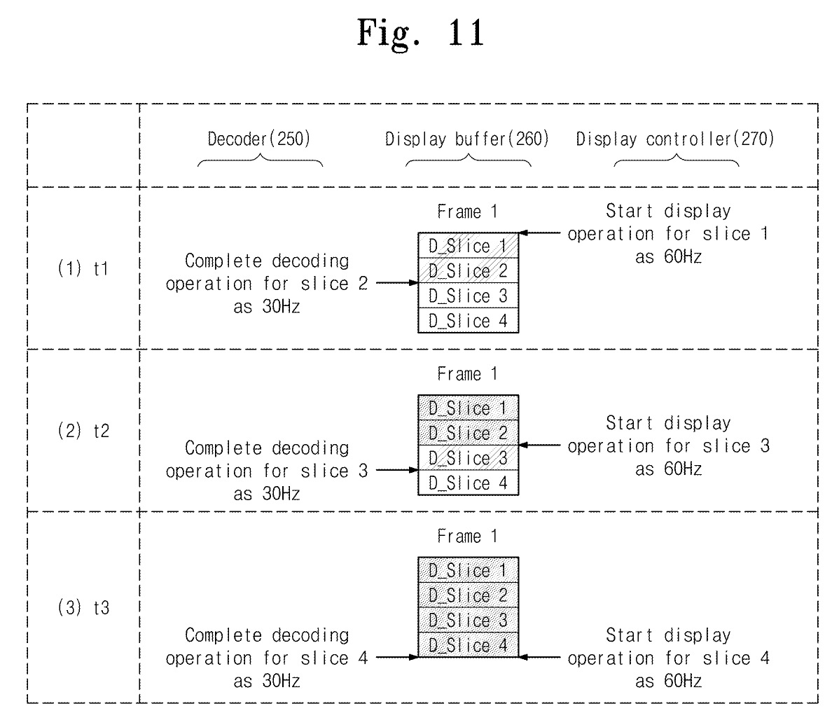

Referring again to FIG. 5, decoder 250 transfers a decoded slice into a display buffer 260, and display controller 270 performs a display operation on a slice stored in display buffer 260. Because a display speed is faster than a decoding speed, an under-run phenomenon may be generated due to a difference between a decoding speed of decoder 250 and a display speed of display controller 270. To prevent the under-run phenomenon, second display device 200 may support a display latency maintain operation. This will be more fully described with reference to FIGS. 10 and 11.

FIG. 10 is a diagram illustrating an under-run phenomenon generated when a second display device in FIG. 5 does not support a display latency maintain operation. For explanation purposes, it is assumed that decoder 250 performs a decoding operation at a speed of 30 Hz and display controller 270 performs a display operation at a speed of 60 Hz.

Referring to FIG. 10, at a first time t1, decoder 250 ends a decoding operation on a first slice, and decoded first slice D_Slice 1 is stored in display buffer 260. Display controller 270 starts to display the decoded first slice D_Slice 1.

At a second time t2, decoder 250 ends a decoding operation on a second slice, and decoded second slice D_Slice 2 is stored in display buffer 260. As indicated above, a display speed may be two times faster than a decoding speed. Thus, at second time t2, display controller 270 may end a display operation on the decoded first and second slices D_Slice 1 and D_Slice 2. Thus, a pointer of decoder 250 and a pointer of display controller 270 may direct the same slice. Under these circumstances, there may be generated an under-run phenomenon where a pointer of display controller 270 antecedes a pointer of decoder 250. Because a decoded fourth slice does not exist, display controller 240 may treat the first frame to be failed or an erroneous display operation may be generated.

FIG. 11 is a diagram illustrating a display latency maintain operation of second display device 200 of FIG. 5. For explanation purposes, it is assumed that decoder 250 performs a decoding operation at a speed of 30 Hz and display controller 270 performs a display operation at a speed of 60 Hz.

To prevent an under-run phenomenon described in FIG. 10, display controller 270 starts to perform a display operation after a predetermined number of decoded slices is stored in a display buffer 260. That is, a predetermined waiting time may be required to start a display operation.

The predetermined waiting time may be referred to as a display latency Latency_dis, and a waiting operation performed by a time corresponding to the display latency may be referred to as a display latency maintain operation. For example, as illustrated in FIG. 11, in the event that one frame is divided into four slices and a display speed is two times faster than a decoding speed, display controller 270 of the inventive concept may start a display operation after a decoding operation on at least two slices is completed. That is, display controller 270 may prevent the under-run phenomenon by performing a display operation after a decoding operation on at least half ones of slices belonging to a frame is completed.

Display latency Latency_dis may be determined variously according to the number of slices and a difference between a decoding speed and a display speed. For example, as the number of slices belonging to a frame increases, the display latency may be set to be short. In other example embodiments, as a difference between a decoding speed and a display speed increases, the display latency may be set to be short.

FIG. 12 is a flowchart illustrating operations of second display device 200 of FIG. 5 according to an embodiment of the inventive concept. The operations of FIG. 12 are described with reference to FIGS. 5 to 12.

In operation S210, CPU 230 checks a number of a slice stored in a network buffer 220. CPU 230 typically determines whether a new slice is transferred from a first display device 100 by periodically checking a number of a slice stored in network buffer 220.

In operation S220, CPU 230 determines whether a new slice is stored in network buffer 220. CPU 230 typically determines whether a new slice is transferred from first display device 100 by periodically checking a number of a slice stored in network buffer 220.

Where a new slice is transferred (S220=Yes), in operation S230 CPU 230 sends it to a frame buffer 240, and a decoder 250 may decode the transferred new slice.

Where no new slice is transferred (S220=No), in operation S240 CPU 230 performs a slice replacing operation of replacing a slice not received with a slice selected from previously received slices. The slice replacing operation is performed according to spatial or temporal locality as described with reference to FIGS. 6 to 9, and may be referred to a jitter removing operation.

In operation S250, display controller 270 determines whether the number of slices stored in display buffer 260 satisfies a predetermined number. As described with reference to FIGS. 10 and 11, such a time that display controller 270 waits by a time corresponding to a display latency Latency_dis may be referred to as a display latency maintain operation.

If the number of slices stored in display buffer 260 satisfies a predetermined number (S250=Yes), in operation S260 display controller 270 may perform a display operation. Otherwise (S250=No), in operation S270 display controller 270 performs a display latency maintain operation.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A display system, comprising:
a first display device configured to transmit information associated each of with multiple frames in slice units; and
a second display device configured to receive the information from the first display device,
wherein where a latency of at least one slice of a selected frame among the multiple frames exceeds a predetermined time, the first display device skips a transfer operation of at least one frame among the multiple frames.

2. The display system of claim 1, wherein the first display device skips the transfer operation on the selected frame.

3. The display system of claim 1, wherein the second display device comprises:
a network buffer configured to store a slice transferred from the first display device; and
a central processing unit configured to check a slice stored in the network buffer periodically,
wherein the central processing unit determines whether the network buffer stores a first slice and a second slice respectively transferred from the first display device at a first time and at a second time, and replaces the second slice using a slice previously stored in the second display device where the second slice is not stored in the network buffer at the second time.

4. The display system of claim 3, wherein the second display device further comprises a frame buffer configured to store slices transferred from the network buffer, and wherein an area of the frame buffer where the selected slice is stored is adjacent to an area of the frame buffer allocated to the second slice.

5. The display system of claim 3, wherein the second display device further comprises a frame buffer configured to store slices transferred from the network buffer,
wherein a receiving time of a first frame to which the selected slice belongs antecedes a receiving time of a second frame which the second slice belongs to, and
wherein an area of the frame buffer at which the selected slice is stored corresponds to an area of the frame buffer allocated to the second slice.

6. The display system of claim 1, wherein the second display device comprises:
a decoder configured to decode slices received from the first display device;
a display buffer configured to store slices decoded by the decoder; and
a display controller configured to display slices stored in the display buffer,
wherein when a decoding speed of the decoder is different from a display speed of the display controller, the display controller performs a display operation after a predetermined number of slices is stored in the display buffer.

7. The display system of claim 1, wherein the information is transmitted and received through a wireless channel.

8. A display device, comprising:
a first buffer unit configured to receive information associated with a frame of an image stream from an external device in slice units;
a second buffer unit configured to receive information associated with a slice from the first buffer unit and to store information associated with multiple slices; and
a control unit configured to control the first and second buffer units and to check information associated with a slice received at the first buffer unit periodically.

9. The display device of claim 8, wherein the control unit checks information associated with slices received in the first buffer unit at a first time and a second time different from the first time, and
wherein where a slice stored in the first buffer unit at the first time is equal to a slice stored in the first buffer unit at the second time, the control unit judges a slice corresponding to the second time not to be received.

10. The display device of claim 9, wherein where a slice corresponding to the second time is determined not to be received, the control unit replaces the slice determined not to be received with a slice selected from multiple slices stored in the second buffer unit.

11. The display device of claim 9, wherein an area of the second buffer unit where the selected slice is stored is adjacent to an area of the second buffer unit allocated to the slice determined not to be received.

12. The display device of claim 10, wherein the second buffer unit comprises a first frame area allocated to a first frame which the selected slice belongs to and a second frame area which the slice determined not to be received belongs to,
wherein a receiving time of the first frame antecedes a receiving time of the second frame, and
wherein an area of the first frame are at which the selected slice is stored corresponds to an area of the second frame area allocated to the slice determined not to be received.

13. The display device of claim 9, further comprising:
a decoder configured to decode slices stored in the second buffer unit; and
a third buffer unit configured to store multiple slices decoded by the decoder,
wherein where a slice corresponding to the second time is determined not to be received, the control unit replaces the slice determined not to be received with one selected from multiple slices stored in the third buffer unit.

14. The display device of claim 13, wherein the selected slice and the slice determined not to be received have temporal locality or spatial locality.

15. The display device of claim 13, further comprising a display controller configured to display multiple slices stored in the third buffer unit on a screen, wherein where a decoding speed of the decoder is different from a display speed of the display controller, the display controller performs a display operation after a predetermined number of slices is stored in the third buffer unit.

16. The display device of claim 15, wherein the display controller sets a number of slices for a start of the display operation to be relatively small where a difference between a decoding speed of the decoder and a display speed of the display controller is relatively large.

17. A method of operating a display system, comprising:
transmitting, by a first display device, information associated each of with multiple frames in slice units;
receiving, by a second display device, the information transmitted by the first display device; and
where a latency of at least one slice of a selected frame among the multiple frames exceeds a predetermined time, skipping, by the first display device, a transfer operation of at least one frame among the multiple frames.

18. The method of claim 17, further comprising skipping, by the first display device, the transfer operation on the selected frame.

19. The method of claim 17, wherein the second display device comprises a network buffer configured to store a slice transferred from the first display device, and a central processing unit configured to check a slice stored in the network buffer periodically, wherein the central processing unit determines whether the network buffer stores a first slice and a second slice respectively transferred from the first display device at a first time and at a second time, and replaces the second slice using a slice previously stored in the second display device where the second slice is not stored in the network buffer at the second time.

20. The method of claim 19, wherein the second display device further comprises a frame buffer configured to store slices transferred from the network buffer, and wherein an area of the frame buffer where the selected slice is stored is adjacent to an area of the frame buffer allocated to the second slice.
